(19) United States
(12) Patent Application Publication
(10) Pub. No.: US 2020/0164668 A1
(43) Pub. Date: May 28, 2020

(54) SHEET PROCESSING DEVICE AND SHEET PROCESSING METHOD

(71) Applicant: SEIKO EPSON CORPORATION, Tokyo (JP)

(72) Inventor: Tetsuya AOYAMA, Shiojiri-shi (JP)

(73) Assignee: SEIKO EPSON CORPORATION, Tokyo (JP)

(21) Appl. No.: 16/695,527

(22) Filed: Nov. 26, 2019

(30) Foreign Application Priority Data
Nov. 27, 2018 (JP) 2018-221157
Jan. 31, 2019 (JP) 2019-015648

(51) Int. Cl. B41J 11/70

(52) U.S. Cl. CPC B41J 11/70

(57) ABSTRACT

A sheet processing device includes a liquid ejection unit which adheres a liquid containing a binder which binds fibers together to a predetermined region of a sheet and a cutting portion which cuts out the region to which the liquid is adhered.

The present application is based on, and claims priority from JP Application Serial Number 2018-221157, filed Nov. 27, 2018 and JP Application Serial Number 2019-015648, filed Jan. 31, 2019, the disclosures of which are hereby incorporated by reference herein in their entirety.

### BACKGROUND

### 1. Technical Field

The present disclosure relates to a sheet processing device and a sheet processing method.

### 2. Related Art

When printing is performed on a sheet using an ink jet head printer, a paper powder generated from the sheet may be stirred up and adhered to a nozzle hole of an ink jet head, and as a result, an ejection defect problem may occur in some cases.

For example, JP-A-2013-107221 has discloses an image forming apparatus which suppresses scattering of a paper powder by applying a liquid to side surfaces of printing sheets placed on a sheet supply stage.

However, in the apparatus disclosed as described above, since the liquid is adhered to the side surfaces of the sheets which are already cut, it is difficult to suppress the generation of the paper powder during the cutting. In particular, since fibers of recycled paper are short, a paper powder thereof is liable to be generated. Furthermore, the amount of the liquid to be adhered to the sheets is preferably set to be small in view of environmental protection and the like.

### SUMMARY

A sheet processing device according to an aspect of the present disclosure comprises: a liquid ejection unit which adheres a liquid containing a binder which binds fibers together to a predetermined region of a sheet; and a cutting portion which cuts out the region to which the liquid is adhered.

The sheet processing device according to the aspect described above may further comprise a control portion which controls the liquid ejection unit so that the liquid is adhered to the region in accordance with an instruction from a user.

In the sheet processing device according to the aspect described above, the binder may be any one of a thermoplastic resin, a thermosetting resin, and a water-soluble resin.

In the sheet processing device according to the aspect described above, in the region to which the liquid is adhered, a rate of the mass of the binder to the mass of the sheet may be 1.0% to 40.0%.

In the sheet processing device according to the aspect described above, the liquid may contain a penetrant.

The sheet processing device according to the aspect described above may further comprise a pressure application portion which applies a pressure to the sheet, and the liquid ejection unit may adhere the liquid in the region of the sheet to which the pressure is applied.

In the sheet processing device according to the aspect described above, the binder may be a thermoplastic resin or a thermosetting resin, and the pressure application portion may be heated.

In the sheet processing device according to the aspect described above, the binder may be a thermoplastic resin or a thermosetting resin, and the cutting portion may be heated.

A sheet processing method according to another aspect of the present disclosure comprises: a step of adhering a liquid containing a binder which binds fibers together to a predetermined region of a sheet using a liquid ejection unit; and a step of cutting out the region to which the liquid is adhered.

### BRIEF DESCRIPTION OF THE DRAWINGS

FIG. 1 is a schematic view showing a sheet manufacturing apparatus according to this embodiment.

FIG. 2 is a schematic view showing a sheet processing device according to this embodiment.

FIG. 3 is a view illustrating a region to which a liquid is adhered by an ink jet head of the sheet processing device according to this embodiment.

FIG. 4 is a schematic view showing a sheet processing method according to this embodiment.

FIG. 5 is a view illustrating Example 1.

FIG. 6 is a view illustrating Comparative Example 1.

FIG. 7 is a table showing the amount of a paper powder and a drying property of a sheet of each of Example 1 and Comparative Examples 1 to 3.

FIG. 8 is a table showing the amount of a paper powder and a drying property of a sheet of each of Examples 2 to 7.

FIG. 9 is a table showing the amount of a paper powder, a tensile strength, a liquid filling property, and a drying property of a sheet of each of Examples 3 and 8 to 17.

FIG. 10 is a table showing compositions of liquids 1 to 5.

FIG. 11 is a table showing the amount of a paper powder and a drying property of a sheet of each of Examples 18 to 21.

### DESCRIPTION OF EXEMPLARY EMBODIMENTS

Hereinafter, preferable embodiments of the present disclosure will be described in detail with reference to the attached drawings. In addition, the following embodiments do not unreasonably limit the contents of the present disclosure described in the claims. In addition, all the elements described below are not always required to be essential constituent elements of the present disclosure.

### 1. Sheet Manufacturing Apparatus

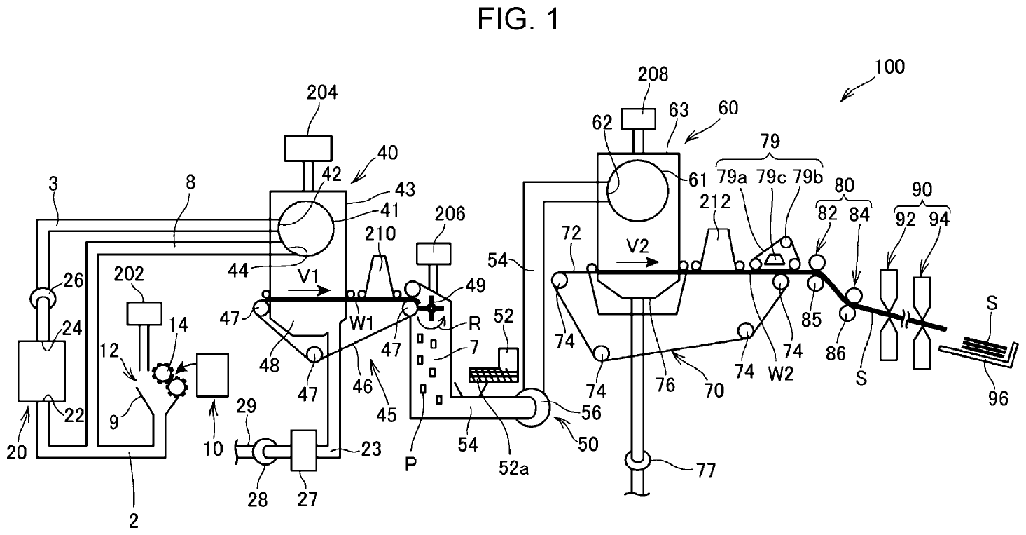

First, a sheet manufacturing apparatus according to this embodiment will be described with reference to the attached drawing. FIG. 1 is a schematic view showing a sheet manufacturing apparatus 100 according to this embodiment.

The sheet manufacturing apparatus 100 is, for example, a preferable apparatus which manufactures new paper by defibrating used waste paper as a raw material into fibers by a dry method, followed by pressure application, heating, and cutting. By various additives which are mixed with the raw material thus defibrated into fibers, in accordance with the application, a bond strength of a paper product and the degree of whiteness thereof may be improved, and/or functions, such as color, smell, and flame retardance, may also be obtained. In addition, since paper is formed while the density, the thickness, and the shape thereof are controlled, in accordance with the application, such as office paper having an A4 or an A3 size or paper for name cards, paper having various thicknesses and sizes can be manufactured.

The sheet manufacturing apparatus 100 includes, for example, a supply portion 10, a coarsely pulverizing portion 12, a defibrating portion 20, a sorting portion 40, a first web forming portion 45, a rotation body 49, a mixing portion 50, a deposition portion 60, a second web forming portion 70, a transport portion 79, a sheet forming portion 80, and a cutting portion 90.

In order to humidify the raw material, a space in which the raw material is transferred, and the like, the sheet manufacturing apparatus 100 further includes humidifying portions 202, 204, 206, 208, 210, and 212.

The humidifying portions 202, 204, 206, and 208 are each formed, for example, of a vaporization type or a hot-wind vaporization type humidifier. That is, the humidifying portions 202, 204, 206, and 208 each have a filter (not shown) to be infiltrated with water and each supply humidified air having an increased humidity by allowing air to pass through the filter. The humidifying portions 202, 204, 206, and 208 each may also include a heater (not shown) which effectively increases the humidity of the humidified air.

The humidifying portions 210 and 212 are each formed, for example, of an ultrasonic type humidifier. That is, the humidifying portions 210 and 212 each include a vibration portion (not shown) which atomizes water and each supply mist generated by the vibration portion.

The supply portion 10 supplies the raw material to the coarsely pulverizing portion 12. The raw material to be supplied to the coarsely pulverizing portion 12 may be any material as long as containing fibers, and for example, there may be mentioned paper, pulp, a pulp sheet, a non-woven cloth, a cloth, or a woven fabric. In this embodiment, the structure of the sheet manufacturing apparatus 100 in which waster paper is used as the raw material will be described by way of example. The supply portion 10 includes, for example, a stacker in which waste paper is stacked and stored and an automatic charge device feeding the waste paper from the stacker to the coarsely pulverizing portion 12. In addition, a plurality of the waste paper is not always required to be aligned and stacked to each other, and waste paper having various sizes and waste paper having various shapes may be irregularly supplied to the stacker.

The coarsely pulverizing portion 12 cuts the raw material supplied by the supply portion 10 using coarsely pulverizing blades 14 into coarsely pulverized pieces. The coarsely pulverizing blade 14 cuts the raw material in a gas such as the air. The coarsely pulverizing portion 12 includes, for example, a pair of the coarsely pulverizing blades 14 which sandwich and cut the raw material and a drive portion which rotates the coarsely pulverizing blades 14 and can be formed to have a structure similar to that of a so-called shredder. The shape and the size of the coarsely pulverized pieces are arbitrary and may be appropriately determined so as to be suitable to a defibrating treatment in the defibrating portion 20. The coarsely pulverizing portion 12 cuts the raw material into pieces having a size of, for example, one centimeter square to several centimeters square or pieces smaller than that described above.

The coarsely pulverizing portion 12 includes a shoot 9 receiving the coarsely pulverized pieces which fall down after being cut by the coarsely pulverizing blades 14. The shoot 9 has, for example, a tapered shape in which the width thereof is gradually decreased in a direction along which the coarsely pulverized pieces flow down. Hence, the shoot 9 is able to receive many coarsely pulverized pieces. A tube 2 which communicates with the defibrating portion 20 is coupled to the shoot 9 to form a transport path through which the coarsely pulverized pieces are transported to the defibrating portion 20. The coarsely pulverized pieces are collected by the shoot 9 and are transported to the defibrating portion 20 through the tube 2. The coarsely pulverized pieces are transported by an air stream generated by, for example, a blower (not shown) toward the defibrating portion 20 through the tube 2.

To the shoot 9 of the coarsely pulverizing portion 12 or the vicinity of the shoot 9, humidified air is supplied by the humidifying portion 202. Accordingly, the coarsely pulverized pieces cut by the coarsely pulverizing blades 14 are suppressed from being adhered to inner surfaces of the shoot 9 and the tube 2 caused by static electricity. In addition, since the coarsely pulverized pieces cut by the coarsely pulverizing blades 14 are transported to the defibrating portion 20 together with humidified air having a high humidity, an effect of suppressing the adhesion of a defibrated material in the defibrating portion 20 can also be anticipated. In addition, the humidifying portion 202 may also be configured so as to supply humidified air to the coarsely pulverizing blades 14 and to remove electricity of the raw material supplied by the supply portion 10. In addition, besides the humidifying portion 202, removal of electricity may also be performed using an ionizer.

The defibrating portion 20 defibrates the coarsely pulverized pieces cut in the coarsely pulverizing portion 12. In more particular, in the defibrating portion 20, the raw material cut by the coarsely pulverizing portion 12 is processed by the defibrating treatment to produce a defibrated material. In this case, the “defibrate” indicates that the raw material formed of fibers bound to each other is disentangled into separately independent fibers. The defibrating portion 20 also has a function to separate substances, such as resin particles, an ink, a toner, and a blurring inhibitor, each of which is adhered to the raw material, from the fibers.

A material passing through the defibrating portion 20 is called a “defibrated material”. In the “defibrated material”, besides the fibers thus disentangled, resin particles, that is, resin particles functioning to bind fibers together; coloring materials, such as an ink and a toner; and additives, such as a blurring inhibitor and a paper reinforcing agent, which are separated from the fibers when the fibers are disentangled, may also be contained in some cases. The defibrated material thus disentangled has a string shape or a ribbon shape. The defibrated material thus disentangled may be present in a state, that is, in an independent state, so as not to be entangled with other disentangled fibers or may be present in a state, that is, in a state in which so-called “damas” are formed, so as to be entangled together to form lumps.

The defibrating portion 20 performs dry defibration. In this case, a treatment, such as defibration, which is performed not in a liquid but in a gas, such as the air, is called a dry type. The defibrating portion 20 is formed, for example, to use an impellor mill. In particular, although not shown in the drawing, the defibrating portion 20 includes a high-speed rotating rotor and a liner disposed around the outer circumference of the rotor. The coarsely pulverized pieces cut by the coarsely pulverizing portion 12 are sandwiched between the rotor and the liner of the defibrating portion 20 and are then defibrated thereby. The defibrating portion 20 generates an air stream by the rotation of the rotor. By this air stream, the defibrating portion 20 sucks the coarsely pulverized pieces functioning as the raw material through the tube 2, and the defibrated material can be transported to a discharge port 24. The defibrated material is fed to a tube 3 from the discharge port 24 and then transported to the sorting portion 40 through the tube 3.

As described above, the defibrated material produced in the defibrating portion 20 is transported to the sorting portion 40 from the defibrating portion 20 by the air stream generated thereby. Furthermore, in the example shown in the drawing, the sheet manufacturing apparatus 100 includes a defibrating blower 26 functioning as an air stream generator, and by an air stream generated by the defibrating blower 26, the defibrated material is transported to the sorting portion 40. The defibrating blower 26 is provided for the tube 3, and air is sucked together with the defibrated material from the defibrating portion 20 and then sent to the sorting portion 40.

The sorting portion 40 includes an inlet port 42 into which the defibrated material defibrated in the defibrating portion 20 flows together with the air stream through the tube 3. The sorting portion 40 sorts the defibrated material introduced into the inlet port 42 by the length of the fibers. In particular, the sorting portion 40 sorts the defibrated material defibrated in the defibrating portion 20 into a defibrated material having a predetermined size or less as a first sorted material and a defibrated material larger than the first sorted material as a second sorted material. The first sorted material includes fibers, particles, and the like, and the second sorted material includes, for example, large fibers, non-defibrated pieces, coarsely pulverizing pieces which are not sufficiently defibrated, and damas which are formed since defibrated fibers are aggregated or entangled with each other.

The sorting portion 40 includes, for example, a drum portion 41 and a housing portion 43 receiving the drum portion 41.

The drum portion 41 is a cylindrical sieve which is rotatably driven by a motor. The drum portion 41 has a net and functions as a sieve. By the meshes of this net, the drum 41 sorts the first sorted material smaller than the sieve opening of the net and the second sorted material larger than the sieve opening of the net. As the net of the drum portion 41, for example, there may be used a metal net, an expanded metal formed by expanding a metal plate provided with cut lines, or a punched metal in which holes are formed in a metal plate by a press machine or the like.

The defibrated material introduced into the inlet port 42 is fed together with the air stream to the inside of the drum portion 41, and by the rotation of the drum portion 41, the first sorted material is allowed to fall down through the meshes of the net of the drum portion 41. The second sorted material which is not allowed to pass through the meshes of the net of the drum portion 41 is guided to a discharge port 44 by the air stream flowing into the drum portion 41 from the inlet port 42 and is then fed to a tube 8.

The tube 8 communicates between the inside of the drum portion 41 and the tube 2. The second sorted material which flows through the tube 8 flows together with the coarsely pulverized pieces cut by the coarsely pulverizing portion 12 in the tube 2 and is then guided to an inlet port 22 of the defibrating portion 20. Accordingly, the second sorted material is returned to the defibrating portion 20 and is then subjected to the defibrating treatment.

In addition, the first sorted material sorted by the drum portion 41 is dispersed in air through the meshes of the net of the drum portion 41 and is then allowed to fall down to a mesh belt 46 of the first web forming portion 45 located under the drum portion 41.

The first web forming portion 45 includes the mesh belt 46, rollers 47, and a suction portion 48. The mesh belt 46 is an endless belt, is suspended by the three rollers 47, and by the movement of the rollers 47, is transported in a direction shown by an arrow in the drawing. The surface of the mesh belt 46 is formed of a net in which openings having a predetermined size are arranged. Of the first sorted material which is allowed to fall down from the sorting portion 40, fine particles passing through the meshes of the net fall down to a lower side of the mesh belt 46, and fibers having a size which are not allowed to pass through the meshes of the net are deposited on the mesh belt 46 and are transported therewith in the arrow direction. The fine particles which fall down through the mesh belt 46 include particles having a relatively small size and/or a low density of the defibrated material, that is, include resin particles, coloring materials, additives, and the like, which are not necessary for binding between the fibers, and the fine particles are unnecessary materials which will not be used for manufacturing of a sheet S by the sheet manufacturing apparatus 100.

The mesh belt 46 is transferred at a predetermined velocity V1 during a normal operation for manufacturing of the sheet S. In the case described above, “during the normal operation” indicates during the operation other than that performing a start control and a stop control of the sheet manufacturing apparatus 100 and, in more particular, indicates during manufacturing of a sheet S having a preferable quality by the sheet manufacturing apparatus 100.

Accordingly, the defibrated material processed by the defibrating treatment in the defibrating portion 20 is sorted into the first sorted material and the second sorted material in the sorting portion 40, and the second sorted material is returned to the defibrating portion 20. In addition, from the first sorted material, the unnecessary materials are removed by the first web forming portion 45. The residues obtained after the unnecessary materials are removed from the first sorted material are a material suitable for manufacturing of the sheet S, and this material is deposited on the mesh belt 46 to form a first web W1.

The suction portion 48 sucks air under the mesh belt 46. The suction portion 48 is coupled to a dust collection portion 27 through a tube 23. The dust collection portion 27 is a filter-type or a cyclone-type dust collection device and separates fine particles from the air stream. A collection blower 28 is provided at a downstream side of the dust collection portion 27 and functions as a dust suction portion which sucks air from the dust collection portion 27. In addition, air discharged from the collection blower 28 is discharged outside of the sheet manufacturing apparatus 100 through a tube 29.

According to the sheet manufacturing apparatus 100, by the collection blower 28, air is sucked from the suction portion 48 through the dust collection portion 27. In the suction portion 48, fine particles passing through the meshes of the net of the mesh belt 46 are sucked together with air and are then fed to the dust collection portion 27 through the tube 23. In the dust collection portion 27, the fine particles passing through the mesh belt 46 are separated from the air stream and are then accumulated.

Hence, fibers obtained after the unnecessary materials are removed from the first sorted material are deposited on the mesh belt 46, and hence, the first web W1 is formed. Since the suction is performed by the collection blower 28, the formation of the first web W1 on the mesh belt 46 is promoted, and in addition, the unnecessary materials can be rapidly removed.

To a space including the drum portion 41, humidified air is supplied by the humidifying portion 204. By this humidified air, the first sorted material is humidified in the sorting portion 40. Accordingly, the adhesion of the first sorted material to the mesh belt 46 caused by static electricity is suppressed, so that the first sorted material is likely to be peeled away from the mesh belt 46. Furthermore, the adhesion of the first sorted material to the rotation body 49 and the inner wall of the housing portion 43 caused by static electricity can be suppressed. In addition, by the suction portion 48, the unnecessary materials can be efficiently sucked.

In addition, in the sheet manufacturing apparatus 100, the structure in which the first sorted material and the second sorted material are sorted and separated is not limited to the sorting portion 40 including the drum portion 41. For example, the structure in which the defibrated material obtained by the defibrating treatment in the defibrating portion 20 is classified by a classifier may also be used. As the classifier, for example, a cyclone classifier, an elbow-jet classifier, or an eddy classifier may be used. When those classifiers are used, the first sorted material and the second sorted material can be sorted and separated. Furthermore, by the classifiers described above, the structure in which materials having a relatively small size and/or a low density, that is, the unnecessary materials, such as resin particles, coloring materials, and additives, which are not necessary for binding between the fibers, in the defibrated material are separated and removed therefrom can be realized. For example, the structure in which fine particles contained in the first sorted material are removed therefrom by a classifier may also be formed. In this case, the structure in which the second sorted material is returned, for example, to the defibrating portion 20, the unnecessary materials are collected by the dust collection portion 27, and the first sorted material other than the unnecessary materials is fed to a tube 54 may be formed.

In a transport path of the mesh belt 46, at a downstream side of the sorting portion 40, air containing mist is supplied by the humidifying portion 210. The mist which is fine particles of water generated by the humidifying portion 210 falls down to the first web W1 and supplies moisture thereto. Accordingly, the moisture amount contained in the first web W1 is adjusted, and hence, for example, the adsorption of the fibers to the mesh belt 46 caused by static electricity can be suppressed.

The sheet manufacturing apparatus 100 includes the rotation body 49 which divides the first web W1 deposited on the mesh belt 46. The first web W1 is peeled away from the mesh belt 46 at a position at which the mesh belt 46 is folded by the roller 47 and is then divided by the rotation body 49.

The first web W1 is a soft material having a web shape formed by deposition of the fibers, the rotation body 49 disentangles the fibers of the first web W1, and hence, the first web W1 is likely to be mixed with a resin in the mixing portion 50 which will be described later.

Although the structure of the rotation body 49 is arbitrarily formed, in the example shown in the drawing, the rotation body 49 has a rotating blade shape having rotatable plate-shaped blades. The rotation body 49 is disposed at a position at which the first web W1 peeled away from the mesh belt 46 is brought into contact with the blade. By the rotation of the rotation body 49, such as the rotation in a direction indicated by an arrow R in the drawing, the first web W1 peeled away from and transported by the mesh belt 46 collides with the blade and is divided thereby, so that divided parts P are produced.

In addition, the rotation body 49 is preferably placed at a position at which the blade of the rotation body 49 does not collide with the mesh belt 46. For example, the distance between a front end of the blade of the rotation body 49 and the mesh belt 46 can be set to be 0.05 to 0.5 mm, and in this case, without causing damage on the mesh belt 46, the first web W1 can be efficiently divided by the rotation body 49.

The divided parts P divided by the rotation body 49 fall down in a tube 7 and are then transported to the mixing portion 50 by an air stream flowing inside the tube 7.

In addition, to a space including the rotation body 49, humidified air is supplied by the humidifying portion 206. Accordingly, a phenomenon in which the fibers are adsorbed by static electricity to the inside of the tube 7 and the blades of the rotation body 49 can be suppressed. In addition, since air having a high humidity is supplied to the mixing portion 50 through the tube 7, influence caused by static electricity on the mixing portion 50 can also be suppressed.

The mixing portion 50 includes an additive supply portion 52 which supplies additives including the resin, the tube 54 which communicates with the tube 7 and through which an air stream containing the divided parts P flows, and a mixing blower 56.

The divided parts P are fibers obtained by removing the unnecessary materials from the first sorted material passing through the sorting portion 40 as described above. The mixing portion 50 mixes the additives including the resin with the fibers which form the divided parts P.

In the mixing portion 50, an air stream is generated by the mixing blower 56, and the divided parts P and the additives are transported in the tube 54 while being mixed together. In addition, the divided parts P are disentangled in a process in which the divided parts P flow inside the tube 7 and the tube 54, so that finer fibrous parts are formed.

The additive supply portion 52 is coupled to an additive cartridge (not shown) in which the additives are stored, and the additives in the additive cartridge are supplied to the tube 54. The additive cartridge may have a structure detachable to the additive supply portion 52. In addition, the additive supply portion 52 may have the structure in which the additives are replenished to the additive cartridge. The additive supply portion 52 temporarily stores the additives in the form of fine powders or fine particles in the additive cartridge. The additive supply portion 52 includes a discharge portion 52a which supplies the temporarily stored additives to the tube 54.

Although not shown in the drawing, the discharge portion 52a includes a feeder which feeds the additives stored in the additive supply portion 52 to the tube 54 and a shutter which opens and closes a path communicating between the feeder and the tube 54. When this shutter is closed, a path or an opening communicating between the discharge portion 52a and the tube 54 is closed, so that the supply of the additives from the additive supply portion 52 to the tube 54 is stopped.

In the state in which the feeder of the discharge portion 52a does not work, although the additives are not supplied from the discharge portion 52a to the tube 54, for example, when a reduced pressure is generated in the tube 54, even if the feeder of the discharge portion 52a is stopped, the additives may flow into the tube 54 in some cases. When the discharge portion 52a is closed, the flow of the additives as described above can be reliably stopped.

The additives supplied by the additive supply portion 52 include a resin which binds a plurality of fibers. The resin included in the additives may be a thermoplastic resin or a thermosetting resin, and for example, there may be mentioned an AS resin, an ABS resin, a polypropylene, a polyethylene, a poly(vinyl chloride), a polystyrene, an acrylic resin, a polyester resin, a poly(ethylene terephthalate), a poly(phenylene ether), a poly(butylene terephthalate), a polyamide, a polycarbonate, a polyacetal, a poly(phenylene sulfide), or a poly(ether ether ketone). Those resins mentioned above may be used alone, or at least two types thereof may be used in combination. That is, the additives each may contain either one single substance or a mixture and may contain a plurality of particles each formed of a single substance or a plurality of substances. In addition, the additives each may have either a fibrous shape or a powder shape.

The resin included in the additives is melted by heating so as to bind fibers together. Hence, in the state in which the resin and the fibers are mixed together, when the resin is not heated to a temperature at which melting thereof occurs, the fibers are not bound to each other.

In addition, besides the resin which binds the fibers together, for example, the additives supplied by the additive supply portion 52 may also include, in accordance with the type of sheet to be manufactured, a coloring agent which colors the fibers, an aggregation suppressor which suppresses aggregation of the fibers and aggregation of the resin, and/or a flame retardant agent which enables the fibers to be unlikely to be combusted. In addition, additives including no coloring agent may have a colorless color, a pale color which is regarded almost as a colorless color, or a white color.

By the air stream generated by the mixing blower 56, the divided parts P falling down in the tube 7 and the additives supplied by the additive supply portion 52 are sucked in the tube 54 and are allowed to pass inside the mixing blower 56. By the air stream generated by the mixing blower 56 and the function of a rotation portion, such as a blade, of the mixing blower 56, the fibers forming the divided parts P and the additives are mixed together, and the mixture thus formed, that is, a mixture of the first sorted material and the additives, is transported to the deposition portion 60 through the tube 54.

In addition, a mechanism in which the first sorted material and the additives are mixed together is not particularly limited and may be stirring which is performed by a blade rotatable at a high speed. In addition, rotation of a container, such as a V type mixer, may also be used, and those mechanisms each may be disposed at an upstream side or a downstream side of the mixing blower 56.

The deposition portion 60 deposits the defibrated material defibrated in the defibrating portion 20. In more particular, the deposition portion 60 introduces the mixture passing through the mixing portion 50 through an inlet port 62 and disentangles the defibrated material thus entangled, so that the defibrated material is allowed to fall down while being dispersed in air. Furthermore, when the resin of the additives supplied from the additive supply portion 52 has a fibrous shape, the deposition portion 60 disentangles the entangled resin. Accordingly, the deposition portion 60 can uniformly deposit the mixture in the second web forming portion 70.

The deposition portion 60 includes a drum portion 61 and a housing portion 63 receiving the drum portion 61. The drum portion 61 is a cylindrical sieve rotatably driven by a motor. The drum portion 61 has a net and functions as a sieve. By the meshes of this net, the drum portion 61 allows fibers and particles, each of which is smaller than the mesh opening of this net, to pass through and fall down from the drum portion 61. For example, the structure of the drum portion 61 is the same as that of the drum portion 41.

In addition, the “sieve” of the drum portion 61 may not have a function to sort a specific object. That is, the “sieve” to be used as the drum portion 61 indicates a member provided with a net, and the drum portion 61 may allows all of the mixture introduced thereinto to fall down.

Under the drum portion 61, the second web forming portion 70 is disposed. The second web forming portion 70 deposits a material passing through the deposition portion 60 to form a second web W2. The second web forming portion 70 includes, for example, a mesh belt 72, rollers 74, and a suction mechanism 76.

The mesh belt 72 is an endless belt, is suspended by the rollers 74, and by the movement of the rollers 74, is transported in a direction shown by an arrow in the drawing. The mesh belt 72 is formed, for example, of a metal, a resin, a cloth, or a non-woven cloth. The surface of the mesh belt 72 is formed of a net in which openings having a predetermined size are arranged. Of the fibers and particles which are allowed to fall down from the drum portion 61, fine particles having a size which are allowed to pass through the meshes of the net fall down to a lower side of the mesh belt 72, and fibers having a size which are not allowed to fall down through the meshes of the net are deposited on the mesh belt 72 and are transported therewith in the arrow direction. The mesh belt 72 is transferred at a predetermined velocity V2 during a normal operation for manufacturing of the sheet S. The “during the normal operation” indicates the same as described above.

The meshes of the net of the mesh belt 72 are fine and may be set so that most of the fibers and particles falling down from the drum portion 61 are not allowed to pass therethrough.

The suction mechanism 76 is provided at a lower side of the mesh belt 72. The suction mechanism 76 includes a suction blower 77, and by a suction force of the suction blower 77, an air stream toward a lower side can be generated in the suction mechanism 76.

By the suction mechanism 76, a mixture dispersed in air by the deposition portion 60 is sucked on the mesh belt 72. Accordingly, the formation of the second web W2 on the mesh belt 72 is promoted, and hence, a discharge rate from the deposition portion 60 can be increased. Furthermore, by the suction mechanism 76, a downflow can be formed in a falling path of the mixture, and hence, the defibrated material and the additives can be prevented from being entangled with each other during the falling.

The suction blower 77 may discharge air sucked from the suction mechanism 76 outside of the sheet manufacturing apparatus 100 through a collection filter (not shown). Alternatively, air sucked by the suction blower 77 may be fed to the dust collection portion 27 so that unnecessary materials contained in the air sucked by the suction mechanism 76 may be collected.

To a space including the drum portion 61, humidified air is supplied by the humidifying portion 208. By this humidified air, the inside of the deposition portion 60 can be humidified, and the adhesion of fibers and particles to the housing portion 63 caused by static electricity is suppressed, so that the fibers and particles are allowed to rapidly fall down on the mesh belt 72, and the second web W2 can be formed to have a preferable shape.

As described above, through the deposition portion 60 and the second web forming portion 70, the second web W2 can be formed so as to be softly expanded with a large amount of air incorporated therein. The second web W2 deposited on the mesh belt 72 is transported to the sheet forming portion 80.

In a transport path of the mesh belt 72, at a downstream side of the deposition portion 60, by the humidifying portion 212, air containing mist is supplied. Accordingly, the mist generated by the humidifying portion 212 is supplied to the second web W2, so that the content of moisture contained in the second web W2 is adjusted. Accordingly, for example, the adsorption of fibers to the mesh belt 72 caused by static electricity can be suppressed.

The sheet manufacturing apparatus 100 includes the transport portion 79 which transports the second web W2 on the mesh belt 72 to the sheet forming portion 80. The transport portion 79 includes, for example, a mesh belt 79a, rollers 79b, and a suction mechanism 79c.

The suction mechanism 79c includes a blower not shown, and by a suction force of the blower, an upward air stream is generated to the mesh belt 79a. This air stream sucks the second web W2, and the second web W2 is separated from the mesh belt 72 and then adsorbed to the mesh belt 79a. The mesh belt 79a is transferred by the rotations of the rollers 79b, so that the second web W2 is transported to the sheet forming portion 80. The transfer rate of the mesh belt 72 is the same, for example, as the transfer rate of the mesh belt 79a.

As described above, the transport portion 79 peels away the second web W2 formed on the mesh belt 72 therefrom and then transports the second web W2 thus peeled away.

The sheet forming portion 80 forms the sheet S from a deposit deposited in the deposition portion 60. In more particular, the sheet forming portion 80 forms the sheet S by heating and pressurizing the second web W2 which is deposited on the mesh belt 72 and is then transported by the transport portion 79. The sheet forming portion 80 binds a plurality of fibers in the mixture to each other with the resin interposed therebetween by heating the fibers of the defibrated material and the additives contained in the second web W2.

The sheet forming portion 80 includes a pressure application portion 82 which pressurizes the second web W2 and a heating portion 84 which heats the second web W2 pressurized by the pressure application portion 82.

The pressure application portion 82 is formed of a pair of calendar rollers 85 which sandwich the second web W2 at a predetermined nip pressure for pressure application. Since the second web W2 is pressurized, the thickness thereof is decreased, and hence, the density of the second web W2 is increased. One of the pair of calendar rollers 85 is a drive roller driven by a motor not shown in the drawing, and the other roller is a driven roller. The calendar rollers 85 are rotated by a driving force of the motor, and the second web W2, the density of which is increased by the pressure application, is transported toward the heating portion 84.

The heating portion 84 is formed, for example, using heating rollers, a heat press forming machine, a hot plate, a hot-wind blower, an infrared heater, or a flash fixing device. In the example shown in the drawing, the heating portion 84 includes a pair of heating rollers 86. The heating rollers 86 are heated to a predetermined temperature by a heater disposed inside or outside. The heating rollers 86 sandwich the second web W2 pressurized by the calendar rollers 85 for heating, so that the sheet S is formed.

One of the pair of heating rollers 86 is a drive roller driven by a motor not shown in the drawing, and the other roller is a driven roller. The heating rollers 86 are rotated by a driving force of the motor, so that the sheet S thus heated is transported toward the cutting portion 90.

As described above, the second web W2 formed in the deposition portion 60 is pressurized and heated in the sheet forming portion 80, so that the sheet S is formed.

In addition, the number of the calendar rollers 85 of the pressure application portion 82 and the number of the heating rollers 86 of the heating portion 84 are not particularly limited.

The cutting portion 90 cuts the sheet S formed in the sheet forming portion 80. In the example shown in the drawing, the cutting portion 90 includes a first cutting portion 92 which cuts the sheet S in a direction intersecting a transport direction of the sheet S and a second cutting portion 94 which cuts the sheet S in a direction parallel to the transport direction. The second cutting portion 94 cuts, for example, the sheet S which passes through the first cutting portion 92.

As described above, a single sheet S having a predetermined size is formed. The single sheet S thus cut is discharged to a discharge portion 96. The discharge portion 96 includes a tray or a stacker on each of which sheets S each having a predetermined size are placed.

In addition, although not shown in the drawing, the humidifying portions 202, 204, 206, and 208 may be formed from one vaporization type humidifier. In this case, the structure may be formed so that humidified air generated by one humidifier is branched and supplied to the coarsely pulverizing portion 12, the housing portion 43, the tube 7, and the housing portion 63. When a duct which supplies humidified air is branched and then installed, the structure described above can be easily realized. In addition, the humidifying portions 202, 204, 206, and 208 may also be formed from two or three vaporization type humidifiers.

In addition, the humidifying portions 210 and 212 may be formed from one ultrasonic type humidifier or may be formed from two ultrasonic type humidifiers. For example, air containing mist generated by one humidifier may be configured to be branched and supplied to the humidifying portions 210 and 212.

In addition, as described above, although the coarsely pulverizing portion 12 pulverizes the raw material, and the sheet S is manufactured from the pulverized raw material, for example, the structure may also be formed so that fibers are used as the raw material, and the sheet S is manufactured therefrom.

For example, the structure may also be formed so that as the raw material, fibers equivalent to the defibrated material obtained by the defibrating treatment performed in the defibrating portion 20 are charged in the drum portion 41. In addition, the structure may also be formed so that as the raw material, fibers equivalent to the first sorted material separated from the defibrated material is charged to the tube 54. In the case described above, when fibers obtained by processing of waste paper, pulp, and the like is supplied to the sheet manufacturing apparatus 100, the sheet S can be manufactured.

### 2. Sheet Processing Device

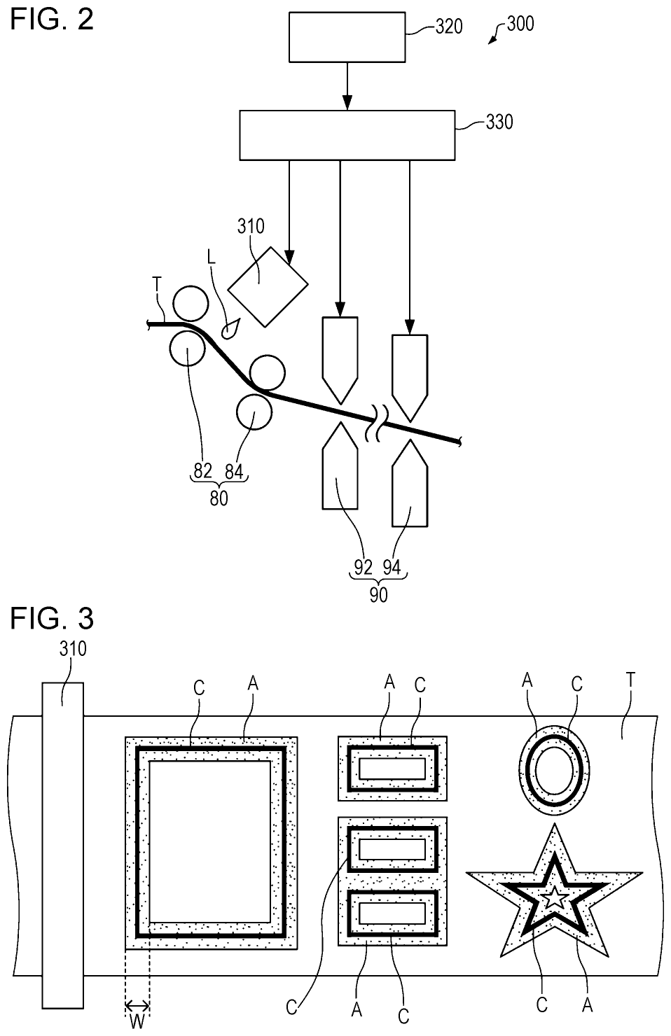

Next, a sheet processing device according to this embodiment will be described with reference to the drawings. FIG. 2 is a schematic view showing a sheet processing device 300 according to this embodiment.

As shown in FIG. 2, the sheet processing device 300 includes, for example, the sheet forming portion 80 having the pressure application portion 82 and the heating portion 84, the cutting portion 90, an ink jet head (liquid ejection unit) 310, a receiving portion 320, and a control portion 330. The sheet manufacturing apparatus 100 described above includes the sheet processing device 300. In addition, for the convenience of illustration, in FIG. 1, the ink jet head 310, the receiving portion 320, and the control portion 330 are omitted in the drawing. In addition, the ink jet head is not limited to a head which ejects an ink and may include any head which can eject a liquid L described below or the like, and a material to be ejected is not required to be a color material or a colorless material.

As shown in FIG. 2, the ink jet head 310 adheres the liquid L to a predetermined region of a sheet T. In the example shown in the drawing, the ink jet head 310 adheres the liquid L to the sheet T pressurized by the pressure application portion 82.

In addition, FIG. 3 is a view illustrating a region A to which the liquid L is adhered by the ink jet head 310. In the example shown in FIG. 3, the ink jet head 310 is a line head type having a width larger than the width of the sheet T. Accordingly, the productivity can be improved.

As shown in FIG. 3, the region A includes a cutting line C to be cut by the cutting portion 90. That is, the cutting portion 90 cuts out the region A to which the liquid L is adhered. The cutting portion 90 does not cut out a region other than the region A of the sheet T. The region A is a cut portion to be cut out by the cutting portion 90. A width W of the region A is, for example, 1 to 30 mm. In the example shown in the drawing, the cutting portion 90 cuts the sheet T into an A4 size, name card sizes, an oval shape, and a star shape. In addition, the shape of the sheet T to be cut out by the cutting portion 90 is not particularly limited.

In addition, when the sheet T is cut into an oval shape and a star shape, the cutting portion 90 may not includes a first cutting portion 92 which cuts the sheet T in a direction intersecting a transport direction of the sheet T and a second cutting portion 94 which cuts the sheet T in a direction parallel to the transport direction thereof and may includes a cutting portion which can be freely moved by a signal from the control portion 330. For example, there may be mentioned a laser cutter or a cutting plotter. The same as described above may also be applied to the case in which the sheet T is cut into an A4 size and a name card size.

The liquid L contains a binder which binds a plurality of fibers contained in the sheet T. As the binder contained in the liquid L, for example, there may be mentioned a thermoplastic resin, a thermosetting resin, or a water-soluble resin. In particular, as the binder, for example, there may be mentioned a styrene-butadiene copolymer, an acrylonitrile-butadiene copolymer, an acrylic acid ester copolymer, a styrene-acrylic acid copolymer, an acrylonitrile-styrene copolymer, an acrylonitrile-butadiene-styrene copolymer, a polyurethane, a polyester, a poly(vinyl acetate), an ethylene-vinyl acetate copolymer, an acrylic resin, a polyacrylamide, a poly(vinyl alcohol), a poly(vinyl pyrrolidone), a polypropylene, a polyethylene, a poly(vinyl chloride), a polystyrene, a poly(ethylene terephthalate), a poly(phenylene ether), a poly(butylene terephthalate), a polyamide, a polycarbonate, a polyacetal, a poly(phenylene sulfide), a poly(ether ether ketone), a cellulose derivative, such as a carboxymethyl cellulose, a hydroxymethyl cellulose, or an agar, a starch such as dextrin, a gelatin, a glue, or a casein. Those binders may be contained alone, or at least two types thereof may be contained in combination. Hereinafter, the case in which as the binder contained in the liquid L, a thermoplastic resin is used will be described.

In the region A to which the liquid L is adhered, the rate of the mass of the binder to the mass of the sheet T is, for example, 1.0% to 40.0%, preferably 5.0% to 40.0%, and more preferably 20.0% to 40.0%. When the rate described above is 1.0% to 40.0%, while the amount of a paper powder generated from the sheet T is decreased, the drying property of the sheet T thus processed can be improved.

The content of the binder in the liquid L is, for example, 0.1 to 30.0 percent by mass and preferably 0.1 to 20 percent by mass. When the content described above is 0.1 to 30.0 percent by mass, the viscosity of the liquid L can be decreased so as to sufficiently eject the liquid L from the ink jet head 310.

The viscosity of the liquid L at 20° C. is preferably 8.0 mPa·s or less. When the viscosity of the liquid L is more than 8.0 mPa·s, the viscosity is excessively high, and hence, the liquid L may not be easily ejected from the ink jet head 310 in some cases.

The glass transition temperature of the thermoplastic resin or the thermosetting resin contained in the liquid L is, for example, −50° C. to 130° C. When the glass transition temperature of the binder is in the range described above, the binding between the fibers can be improved, and the amount of a paper powder generated when the sheet T is cut can be decreased.

The liquid L may contain a penetrant. Accordingly, the infiltration of the liquid L in a thickness direction of the sheet T is improved, and hence, fiber binding in the sheet T can be improved, and the amount of the paper powder generated when the sheet T is cut can be decreased. As the penetrant contained in the liquid L, for example, there may be mentioned a glycol ether, such as triethylene glycol monobutyl ether, triethylene glycol dimethyl ether, triethylene glycol diethyl ether, triethylene glycol dibutyl ether, or triethylene glycol methyl butyl ether; a silicone-based surfactant, an acetylene glycol-based surfactant, an acetylene alcohol-based surfactant, or a fluorine-based surfactant. The content of the penetrant in the liquid L is preferably 1 to 30 percent by mass and more preferably 3 to 20 percent by mass. When the content is in the range as described above, the infiltration of the liquid L in the sheet T is promoted, and hence, the amount of the paper powder generated from the sheet T can be decreased.

The liquid L may contain a moisturizer. Accordingly, when the liquid L is ejected by the ink jet head 310, clogging of a nozzle hole of the ink jet head 310 may be unlikely to occur. As the moisturizer contained in the liquid L, for example, there may be mentioned diethylene glycol, triethylene glycol, propylene glycol, dipropylene glycol, 1,3-propanediol, 1,3-butylene glycol, 1,4-butanediol, 1,5-pentanediol, 1,6-hexanediol, 2-ethyl-2-methyl-1,3-propanediol, 2-methyl-2-propyl-1,3-propanediol, 2-methyl-1,3-propanediol, 2,2-dimethyl-1,3-propanediol, 3-methyl-1,3-propanediol, 1,2-hexanediol, 2-ethyl-1,3-hexanediol, 3-methyl-1,5-penetandiol, 2-methylpenetane-2,4-diol, trimethylolpropane, or glycerin.

The liquid L may contain water. As the water, purified water or ultra purified water, such as ion-exchanged water, ultrafiltrated water, reverse osmosis water, or distilled water, is preferably used. In addition, water sterilized by UV irradiation or addition of hydrogen peroxide is preferable since the generation of fungi and/or bacterial can be prevented, and long storage can be performed.

As other additives to be contained in the liquid L, for example, there may be mentioned an UV absorber, a light stabilizer, a quencher, an antioxidant, a water resistant agent, a fungicide, an antiseptic agent, a thickening agent, a flow modifier, a pH adjuster, a defoaming agent, an antifoam agent, a leveling agent, and/or a antistatic agent.

As shown in FIG. 2, the receiving portion 320 is a device which receives an input from a user and which outputs input information to the control portion 330. The function of the receiving portion 320 is realized by an input device, such as a keyboard, a mouse, a bottom, or a touch panel. The receiving portion 320 receives an input which instructs the shape, the size, and the position of the sheet T to be cut by the cutting portion 90.

The control portion 330 controls the ink jet head 310 so that the liquid L is adhered to the region A in accordance with the instruction from the user. In particular, the control portion 330 enables the ink jet head 310 to adhere the liquid L to the region A based on an output signal from the receiving portion 320. Furthermore, the control portion 330 enables the cutting portion 90 to cut the cutting line C of the sheet T in accordance with the output signal from the receiving portion 320. The functions of the control portion 330 can be realized by a hardware, such as various types of processors (a CPU, a DSP, and the like) and ASICs (such as a gate array), or a program.

When the sheet T to which the liquid L is adhered passes through the heating portion 84, the binder contained in the liquid L is melted so as to bind the fibers together contained in the sheet T.

The pressure application portion 82 and the cutting portion 90 may be heated. The pressure application portion 82 and the cutting portion 90 may be heated, for example, to a temperature of 80° C. to 200° C. A method to heat the pressure application portion 82 and the cutting portion 90 is not particularly limited. In addition, although not shown in the drawing, besides the heated pressure application portion 82, the heated cutting portion 90, and the heating portion 84, the sheet T to which the liquid L is adhered may also be separately heated by hot wind, infrared rays, electromagnetic waves, heating rollers, a thermal press, or the like. Accordingly, melt binding and/or gluing of the binder contained in the liquid L can be promoted.

The sheet processing device 300 has, for example, the following features.

The sheet processing device 300 includes the ink jet head 310 which adheres the liquid L containing the binder which binds fibers together to the predetermined region A of the sheet T and the cutting portion 90 which cuts out the region A to which the liquid L is adhered. Hence, compared to the case in which a region to which no liquid L is adhered is cut out, by the sheet processing device 300, the amount of the paper powder generated when the sheet T is cut can be decreased. Accordingly, as described below in “4. Examples and Comparative Examples”, when the sheet T processed by the sheet processing device 300 is printed, for example, by an ink jet printer, the paper powder generated from the sheet during the cutting is suppressed from being stirred up and adhered to the nozzle hole of the ink jet head. In addition, for example, when the sheet T processed by the sheet processing device 300 is printed by a laser printer, the paper powder generated from the sheet during the cutting is suppressed from being stirred up and adhered to a photosensitive body of the laser printer. Hence, according to the sheet T processed by the sheet processing device 300, dot missing caused by the paper powder can be suppressed.

Furthermore, compared to the case in which the liquid L is adhered over the entire surface of the sheet T, the use amount of the liquid L can be decreased. Hence, the drying property of the sheet T can be improved, and the productivity can also be improved. In addition, since the energy required to dry the sheet T is decreased, the electric power can be saved. Furthermore, the probability of cutting the sheet T by the tension between the pressure application portion 82 and the heating portion 84 can be reduced.

As described above, by the sheet processing device 300, while the use amount of the liquid L is decreased, the amount of the paper powder can be decreased.

The sheet processing device 300 may includes the control portion 330 which controls the ink jet head 310 so that the liquid L is adhered to the region A in accordance with the instruction from the user. Hence, according to the sheet processing device 300, the shapes, the number, and the formation order of the sheets T, each of which is cut by the cutting portion 90, can be determined by on-demand basis. For example, the shape of the sheet T to be cut may be set to an A4 size, a name card size, an oval size, or a star size; the number of A4 size or name card size sheets may be set to three or two, respectively: or the formation order may be set so that the A4 size is formed, followed by the formation of the name card size. In addition, after the basis weight of the sheet T is obtained, the amount of the liquid L to be ejected from the ink jet head 310 may be determined in accordance with the basis weight described above.

According to the sheet processing device 300, the binder contained in the liquid L may be a styrene-butadiene copolymer. Hence, according to the sheet processing device 300, as described below in “4. Examples and Comparative Examples”, compared to the case in which as the binder contained in the liquid L, a polyurethane, a styrene-acrylic acid copolymer, an ethylene-vinyl acetate copolymer, a polyacrylamide, or a poly(vinyl alcohol), is used, the amount of the paper powder can be decreased, and in addition, the tensile strength of the sheet can be increased.

According to the sheet processing device 300, the rate of the mass of the binder to the mass of the sheet T in the region A to which the liquid L is adhered may be 1.0% to 40.0%. Hence, according to the sheet processing device 300, as described below in “4. Examples and Comparative Examples”, while the amount of the paper powder is decreased, the drying property of the sheet T thus processed can be improved.

According to the sheet processing device 300, the liquid L may contain the penetrant. Hence, according to the sheet processing device 300, as described below in “4. Examples and Comparative Examples”, compared to the case in which no penetrant is contained, the amount of the paper powder can be decreased.

The sheet processing device 300 includes the pressure application portion 82 which pressurizes the sheet T, and the ink jet head 310 may adhere the liquid L to the region A of the sheet T pressurized thereby. The density of the sheet T thus pressurized is preferably 0.09 g/cm³ or more. Hence, according to the sheet processing device 300, compared to the case in which the liquid L is adhered to the sheet T in the state of web which is not yet pressurized, the liquid L is likely to be infiltrated in the sheet T. Since the infiltration of the liquid L in the sheet T is caused by a capillary phenomenon, compared to the web containing a large amount of air, in the state in which the amount of air is decreased by the pressure application, the liquid L is likely to be infiltrated.

According to the sheet processing device 300, the binder contained in the liquid L may be a thermoplastic resin or a thermosetting resin, and the pressure application portion 82 may be heated. Hence, according to the sheet processing device 300, as described below in “4. Examples and Comparative Examples”, compared to the case in which the pressure application portion 82 is not heated, the fusion between the fibers by the binder can be promoted, and the amount of the paper powder can be decreased.

According to the sheet processing device 300, the binder contained in the liquid L may be a thermoplastic resin or a thermosetting resin, and the cutting portion 90 may be heated. Hence, according to the sheet processing device 300, as described below in “4. Examples and Comparative Examples”, compared to the case in which the cutting portion is not heated, the fusion between the fibers by the binder can be promoted, and the amount of the paper powder can be decreased.

In addition, although not shown in the drawing, the ink jet head 310 may adhere the liquid L to the sheet T which is not yet pressurized by the pressure application portion 82. In the case described above, the sheet T may be in a web state. That is, the sheet T may be either in a state in which the pressure application is performed by the pressure application portion 82 or in a web state not yet pressurized by the pressure application portion 82.

In addition, according to the ink jet head 310, the liquid L may be adhered to the sheet T which is heated in advance by the heating portion 84. In the case described above, the sheet T to which the liquid L is adhered may be separately heated by hot wind, infrared rays, electromagnetic waves, or the like.

In addition, the sheet processing device 300 may function as a part of the sheet manufacturing apparatus 100 shown in FIG. 1 so as to process a sheet formed therein or a commercially obtained sheet. The sheet which is processed by the sheet processing device 300 may be either a sheet formed by a dry paper making step as that of the sheet manufacturing apparatus 100 or a sheet formed by a general wet paper making method.

In addition, the ink jet head 310 may be not a line head type (single-pass method) and may be a multi-pass method in which the head itself moves.

### 3. Sheet Processing Method

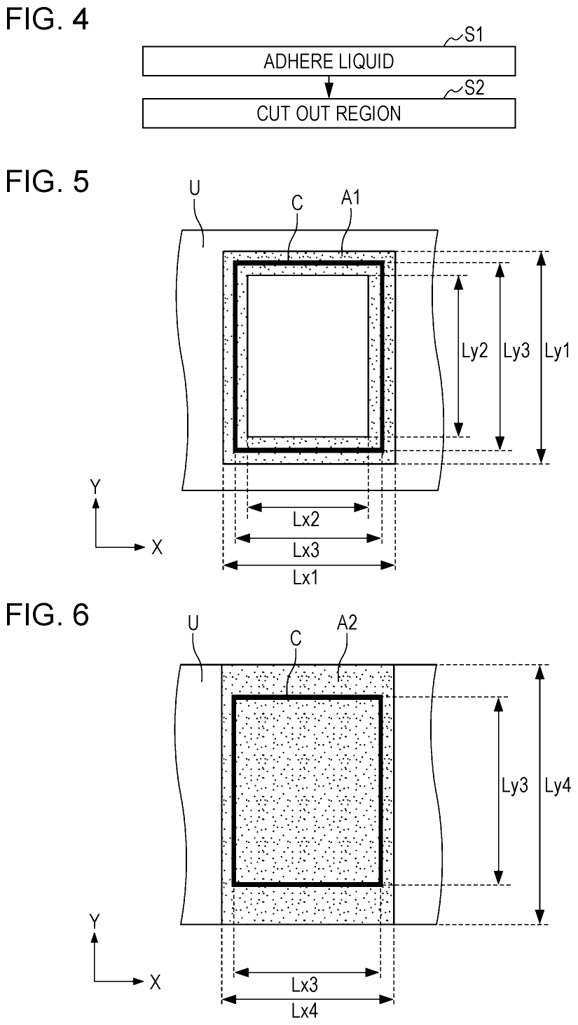

Next, a sheet processing method according to this embodiment will be described with reference to the drawing. FIG. 4 is a flowchart illustrating the sheet processing method according to this embodiment. The sheet processing method according to this embodiment uses, for example, the sheet processing device 300.

As shown in FIG. 4, by the use of the ink jet head 310, to the predetermined region A of the sheet T, the liquid L containing the binder which binds the fibers together is adhered (Step S1). Next, the region A to which the liquid L is adhered is cut out (Step S2). The other steps are the same as those described above.

### 4. Examples and Comparative Examples

Hereinafter, with reference to Examples and Comparative Examples, the present disclosure will be described in more detail. In addition, the present disclosure is not limited to the following Examples and Comparative Examples.

### 4.1. Evaluation of Application Method of Liquid

### 4.1.1. Formation of Sheet

### (1) Example 1

As a raw material, recycled paper “G80” (manufactured by Mitsubishi Paper Mills Limited) was used, and by the use of a sheet manufacturing apparatus “PaperLab A-8000” manufactured by Seiko Epson Corporation, a continuous sheet U having a basis weight of 90 g/m² was formed without performing a step of cutting the sheet.

Next, as shown in FIG. 5, a liquid L was applied to a region A1 of the continuous sheet U, followed by heat drying. In FIG. 5, as two axes orthogonal to each other, an X axis and a Y axis are shown. The continuous sheet U was transported in an X axis direction.

The region A1 included a cutting line C to be cut. The cutting line C was formed to have an A4 size, and the region A1 was formed to have a frame shape. In the X axis direction, an outside length Lx1 of the region A1, an inside length Lx2 of the region A1, and a length Lx3 of the cutting line C were set to 220 mm, 200 mm, and 210 mm, respectively. In a Y axis direction, an outside length Ly1 of the region A1, an inside length Ly2 of the region A1, and a length Ly3 of the cutting line C were set to 307 mm, 287 mm, and 297 mm, respectively.

The application of the liquid L was performed using an ink jet printer “PX-S160T” manufactured by Seiko Epson Corporation. After the liquid L was applied to a surface of the continuous sheet U, by the use of a thermal press machine, heat drying was performed at 150° C. and 10 kN for 30 seconds. Subsequently, the liquid L was also applied to a rear surface of the continuous sheet U so as to coincide with the portion at which the application was performed on the surface of the continuous sheet U, followed by heat drying as described above.

In this example, as the liquid L, a liquid containing 10 percent by mass of a binder, 5 percent by mass of a penetrant, and 5 percent by mass of a moisturizer, with the balance being water, that is, the total of which was 100 percent by mass, was used. As the binder, a styrene-butadiene copolymer was used. In particular, as the styrene-butadiene copolymer, “Nipol LX430” manufactured by Zeon Corporation was used. The glass transition temperature thereof was 12° C. As the penetrant, 4 percent by mass of triethylene glycol monobutyl ether and 1 percent by mass of “BYK-348” manufactured by BYK Japan KK, which was used as a silicone-based surfactant, were used. As the moisturizer, glycerin was used.

In the region A1 to which the liquid L was adhered, the application amount of the binder per unit area was 48.1 g/m², and the use amount of the binder in the region A1 to which the liquid L was adhered was 0.48 g. In the region A1 to which the liquid L was adhered, a rate R of the mass of the binder to the mass of the continuous sheet U was 5.3%. The viscosity of the liquid L at a temperature of 20° C. was 5.2 mPa·s when measured using a vibration type viscometer “VM100A” manufactured by Sekonic Corporation.

Next, the cutting line C of the continuous sheet U was cut using a cutting machine “CE600-40” manufactured by Graphtec. As a result, a sheet having an A4 size of Example 1 was formed.

### (2) Comparative Example 1

Except for that instead of using the ink jet printer, by using a roll coater, the liquid L was applied to a region A2 of the continuous sheet U as shown in FIG. 6, a sheet of Comparative Example 1 was similar to that of Example 1. The use amount of the binder in the region A2 to which the liquid L was adhered was 0.48 g. In the region A2 to which the liquid L was adhered, the rate R of the mass of the binder to the mass of the continuous sheet U was significantly smaller than 5.3%. A length Lx4 in the X axis direction of the region A2 and a length Ly4 in the Y axis direction of the region A2 were set to 220 mm and 329 mm, respectively.

### (3) Comparative Example 2

Except for that the use amount of the binder in the region A2 to which the liquid L was adhered was set to 3.45 g, and the rate R was set to 5.3%, a sheet of Comparative Example 2 was similar to that of Comparative Example 1.

### (4) Comparative Example 3

Except for that no liquid L was applied to the continuous sheet U, a sheet of Comparative Example 3 was similar to that of Comparative Example 1.

### 4.1.2 Evaluation Results

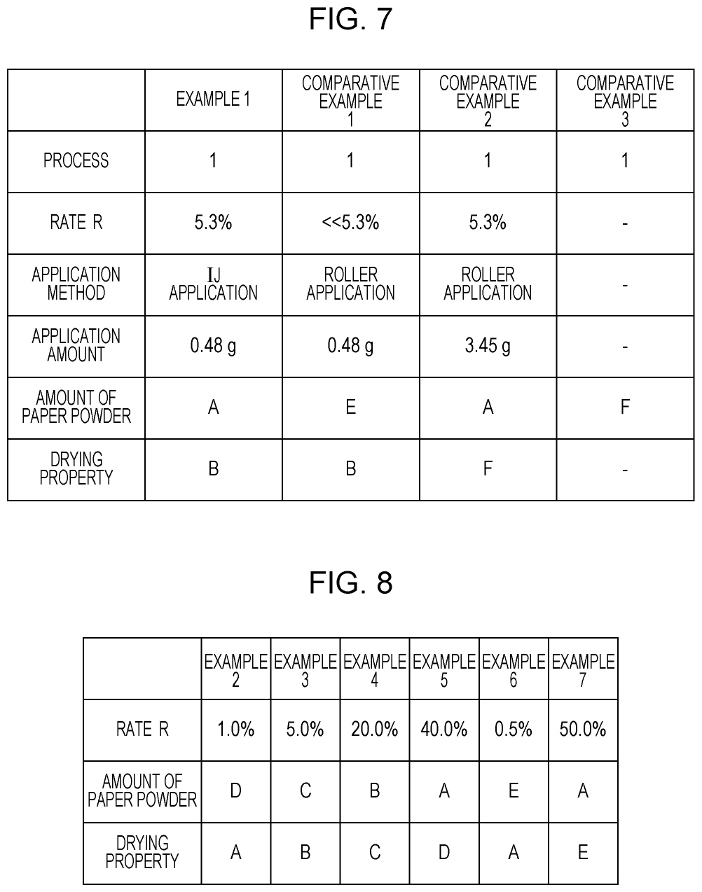

By using the sheets of Example 1 and Comparative Examples 1 to 3 formed as described above, the application method of the liquid L was evaluated. FIG. 7 is a table showing the amount of the paper powder and the drying property of the sheet of each of Example 1 and Comparative Examples 1 to 3.

The amount of the paper powder was evaluated as described below. In a clean room of class 1,000,000, 30 sheets each cut into an A4 size were continuously supplied to an ink jet printer “PX-049A” manufactured by Seiko Epson Corporation. In this operation, a suction port of a particle counter was inserted from the bottom of the printer, and from the start to the stop of the paper supply, the number of particles having a size of 10 μm or more was counted. As the particle counter, “KC-52” manufactured by Rion Co., Ltd. was used, and a suction volume was set to 10 L. In particular, the particles thus measured were fibers having a length of 1 to 2 mm and a width of approximately 20 μm.

The amount of the paper powder was evaluated in accordance with the following criteria.

A: A counter value of 100 or less

D: A counter value of more than 100 to 150

E: A counter value of more than 150 to 200

F: A counter value of more than 200

The drying property was evaluated by measuring a moisture rate immediately after heat drying of the continuous sheet U to which the liquid L was applied. The moisture rate was measured by a heat drying moisture meter “MX-50” manufactured by A&D Company, Limited. In addition, the moisture rate was measured in an environment at 23° C. and 50% RH.

The drying property was evaluated in accordance with the following criteria.

A: A moisture rate of 6% or less

B: A moisture rate of more than 6% to 10%

C: A moisture rate of more than 10% to 20%

D: A moisture rate of more than 20% to 30%

E: A moisture rate of more than 30% to 40%

F: A moisture rate of more than 40%.

In FIG. 7, “1” in the “Process” indicates the case in which the continuous sheet is formed using a sheet manufacturing apparatus. In addition, in FIG. 7, “IJ Application” in the “Application Method” indicates the application by an ink jet head, and “Roller Application” indicates the application by a roll coater.

As shown in FIG. 7, in Example 1, although the use amount of the liquid L is the same as that of Comparative Example 1, the amount of the paper powder is smaller than that in Comparative Example 1. In Comparative Example 2, although the amount of the paper powder is small similar to that in Example 1, the use amount of the liquid L is 7 times or more that in Example 1. Hence, in Comparative Example 2, the drying property is inferior. Furthermore, in Example 1, the amount of the paper powder is small as compared to that of Comparative Example 3 in which no liquid L is applied.

Accordingly, it is found that since the liquid L is adhered to a portion to be cut using the ink jet head, while the use amount of the liquid L is decreased, the amount of the paper powder can be decreased.

### 4.2. Evaluation of Application Amount of Liquid

By using the sheets of Examples 2 to 7, the application amount of the liquid L was evaluated. In particular, the application amount of the liquid L was changed, and the amount of the paper powder and the drying property were evaluated. FIG. 8 is a table showing the amount of the paper powder and the drying property of the sheet of each of Examples 2 to 7. In Examples 2 to 7, since the application amount of the liquid L was changed from that in Example 1, except for that the rate R of the mass of the binder to the mass of the continuous sheet U was changed, a sheet of each of Examples 2 to 7 was similar to that of Example 1.

The amount of the paper powder was evaluated in accordance with the following criteria.

A: A counter value of 20 or less

B: A counter value of more than 20 to 50

C: A counter value of more than 50 to 100

D: A counter value of more than 100 to 150

E: A counter value of more than 150 to 200

F: A counter value of more than 200.

In addition, the evaluation method of the amount of the paper powder and the evaluation method of the drying property are the same as described in “4.1. Evaluation of Application Method of Liquid”.

FIG. 8 indicates that as the rate R is increased, the application amount of the liquid L is increased. As shown in FIG. 8, as the rate R is increased, the amount of the paper powder is decreased. Furthermore, as the rate R is decreased, the drying property is improved. It is found that when the rate R is set in a range of 1.0% to 40.0%, while the amount of the paper powder is decreased, the drying property can be improved.

### 4.3. Evaluation of Composition of Liquid

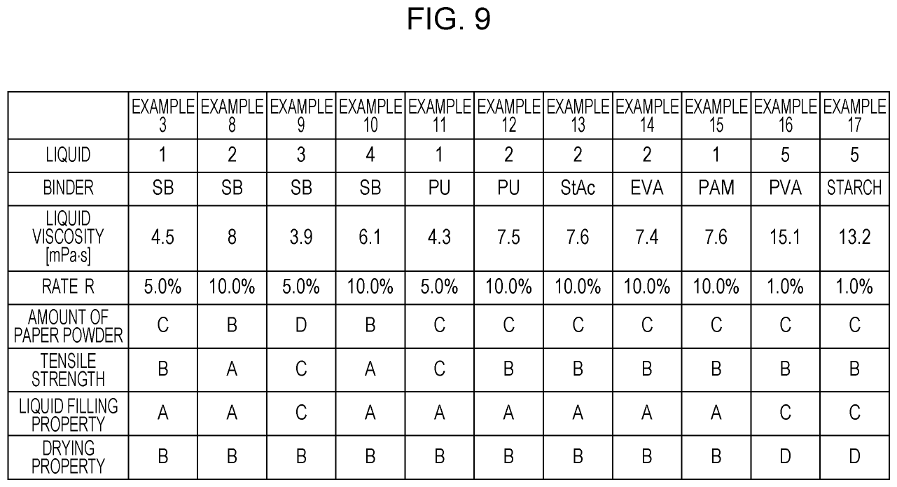

By using the sheet of each of Examples 3 and 8 to 17, the composition of the liquid L was evaluated. In particular, the composition of the liquid L was changed, and the amount of the paper powder, the tensile strength, a liquid filling property, and the drying property were evaluated. FIG. 9 is a table showing the amount of the paper powder, the tensile strength, the liquid filling property, and the drying property of the sheet of each of Examples 3 and 8 to 17. Except for that the composition of the liquid L is changed from that of Example 1, a sheet of each of Examples 8 to 17 is similar to that of Example 1.

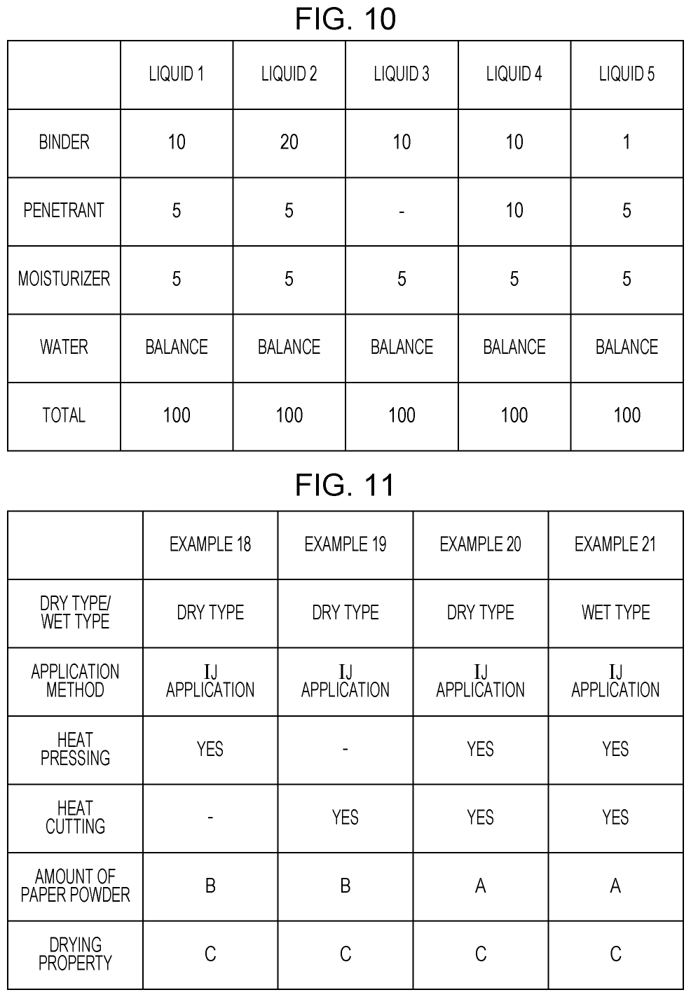

FIG. 10 is a table showing the compositions of liquids 1 to 5 each used as the liquid L, and the unit of the numerical value indicates percent by mass. The penetrant and the moisturizer are the same as those used in Example 1. In addition, various types of binders are used for Examples.

In FIG. 9, the symbol of “Binder” indicates the following.

SB: Styrene-butadiene copolymer

PU: Polyurethane

StAC: Styrene-acrylic acid copolymer

EVA: Ethylene-vinyl acetate copolymer

PAM: Polyacrylamide

PVA: Poly(vinyl alcohol)

In FIG. 9, “Liquid Viscosity” indicates the viscosity of the liquid L at 20° C.

The amount of the paper powder and the drying property were evaluated by an evaluation method and evaluation criteria similar to those described in “4.2. Evaluation of Application Amount of Liquid”.

The tensile strength was measured using a tensile tester AGS-X 500 N manufactured by Shimadzu Corporation by a method described in “JIS P8113: 2006”. The sample had a width of 20 mm.

The tensile strength was evaluated in accordance with the following criteria.

A: A tensile strength of 50 N or more

B: A tensile strength of 20 N to less than 50 N

C: A tensile strength of less than 20 N

The liquid filling property was evaluated as described below. By using an ink jet printer “PX-S160T”, the liquid L was filled in the head using an ink tube refresh command of the printer. Subsequently, a nozzle check pattern was printed.

The liquid filling property was evaluated in accordance with the following criteria.

A: The liquid was normally ejected from all the nozzles.

C: The liquid L was not ejected from some of the nozzles.

As shown in FIG. 9, by comparison between Examples 3 and 9, it is found that when the liquid L contains the penetrant, the evaluations of the amount of the paper powder, the tensile strength, and the liquid filling property are improved. In addition, by comparison of Example 8 with Examples 12 to 15, it is found that by the styrene-butadiene copolymer, the evaluations of the amount of the paper dust and the tensile strength are improved as compared to those by the other binders. In addition, in Examples 16 and 17, the liquid viscosity is increased, and the liquid filling property and the drying property are degraded.

### 4.4. Evaluations of Heat Pressing and Heat Cutting

By using the sheets of Examples 18 to 21, heat pressing and heat cutting were evaluated. In particular, the amount of the paper powder and the drying property by the heat pressing and the heat cutting were evaluated. FIG. 11 is a table showing the amount of the paper powder and the drying property of the sheet of each of Examples 18 to 21.

Except for that the rate R of the mass of the binder to the mass of the continuous sheet U was 5.4%, a sheet of Example 18 was similar to that of Example 1.

Except for that the heat pressing was not performed, and the heat cutting was performed, a sheet of Example 19 was similar to that of Example 18. In this case, the “heat pressing” indicates heat drying performed at 150° C. and 10 kN for 30 seconds by a heat press machine. The “heat cutting” indicates that cutting is performed using a cutter heated to 100° C.

Except for that the heat cutting was performed, a sheet of Example 20 was similar to that of Example 18.

Except for that the liquid L was applied to recycled paper “G80” formed by a general wet paper making method without using a sheet manufacturing apparatus “PaperLab A-8000”, followed by heat cutting, a sheet of Example 21 was similar to that of Example 18.

In Examples 18 to 20, the sheet was formed by a dry paper making step, and in Example 21, the sheet was formed by a wet paper making step.

The amount of the paper powder and the drying property were evaluated by an evaluation method and evaluation criteria similar to those described in “4.2. Evaluation of Application Amount of Liquid”.

As shown in FIG. 11, in Example 20 in which the heat pressing and the heat cutting are both performed, the amount of the paper powder is small as compared to that in each of Examples 18 and 19 in which one of the heat pressing and the heat cutting is only performed. It is found that when at least one of the heat pressing and the heat cutting is performed, the amount of the paper powder can be decreased as compared to that obtained when both the heat pressing and the heat cutting are not performed. In addition, it is also found that when the liquid L is adhered to the portion to be cut, in the sheet formed by a wet paper making step, the amount of the paper powder can also be decreased.

In the present disclosure, within the range in which the features and the advantages of the present disclosure are obtained, the structure may be partially omitted, or the embodiments and the modified examples may be arbitrarily used in combination.

The present disclosure is not limited to the embodiments described above and may be variously changed or modified. For example, the present disclosure includes substantially the same structure as the structure described in the embodiment. The substantially the same structure includes, for example, the structure in which the function, the method, and the result are the same as those described above, or the structure in which the object and the effect are the same as those described above. In addition, the present disclosure includes the structure in which a nonessential portion of the structure described in the embodiment is replaced with something else. In addition, the present disclosure includes the structure which performs the same operational effect as that of the structure described in the embodiment or the structure which is able to achieve the same object as that of the structure described in the embodiment. In addition, the present disclosure includes the structure in which a known technique is added to the structure described in the embodiment.

What is claimed is:

1. A sheet processing device comprising:
a liquid ejection unit which adheres a liquid containing a binder which binds fibers together to a predetermined region of a sheet; and
a cutting portion which cuts out the region to which the liquid is adhered.

2. The sheet processing device according to claim 1, further comprising:
a control portion which controls the liquid ejection unit so that the liquid is adhered to the region in accordance with an instruction from a user.

3. The sheet processing device according to claim 1,
wherein the binder is any one of a thermoplastic resin, a thermosetting resin, and a water-soluble resin.

4. The sheet processing device according to claim 1,
wherein in the region to which the liquid is adhered, a rate of the mass of the binder to the mass of the sheet is 1.0% to 40.0%.

5. The sheet processing device according to claim 1,
wherein the liquid contains a penetrant.

6. The sheet processing device according to claim 1, further comprising:
a pressure application portion which applies a pressure to the sheet,
wherein the liquid ejection unit adheres the liquid to the region of the sheet to which the pressure is applied.

7. The sheet processing device according to claim 6,
wherein the binder is a thermoplastic resin or a thermosetting resin, and
the pressure application portion is heated.

8. The sheet processing device according to claim 1,
wherein the binder is a thermoplastic resin or a thermosetting resin, and
the cutting portion is heated.

9. A sheet processing method comprising:
adhering a liquid containing a binder which binds fibers together to a predetermined region of a sheet using a liquid ejection unit; and
cutting out the region to which the liquid is adhered.
